(19) United States
(12) Patent Application Publication
(10) Pub. No.: US 2008/0020696 A1
(43) Pub. Date: Jan. 24, 2008

(54) Air-cooled motor

(75) Inventor: Georges A.M. Van Gansen, Kowloon (HK)

Correspondence Address: RABIN & Berdo, PC, 1101 14TH STREET, NW, SUITE 500, WASHINGTON, DC, 20005, US

(73) Assignee: SCORPION PRECISION INDUSTRY (H.K.) CO., LTD., Kowloon (HK)

(21) Appl. No.: 11/511,269

(22) Filed: Aug. 29, 2006

(30) Foreign Application Priority Data
Jul. 19, 2006 (CN) 200610105739.4

(51) Int. Cl. B60S 1/54

(52) U.S. Cl. 454/126

(57) ABSTRACT

An air-cooled motor is disclosed, comprising a motor shaft, a stator and a rotor which are disposed co-axially, said motor shaft being fitted with a fixed seat for supporting said stator and being operatably connected with said rotor and rotatably connected with said stator, said stator having a coil coupled to conductive wires; further comprising a front cover disposed at the front side of said rotor and having wind channels, wherein a front end portion of said rotor in the proximity of said front cover is provided with an air-inflow disk which has one or more air intake grooves each passing obliquely therethrough to form a windward angle relative to the rotation direction of said rotor; and said motor further comprises an air-exhausting disk which has one or more air outlet grooves each passing obliquely therethrough to form a windward angle relative to the rotation direction of said rotor.

### FIELD OF THE INVENTION

The present invention relates to the field of electrical machinery, and particularly to an electric motor with internally forced air cooling system.

### BACKGROUND OF THE INVENTION

Most of commercially available motors, based on the principle of electromagnetic effect, structurally include a coil used as a stator and a metallic sleeve having magnets used as a rotor. When the motor is in its operation state, the coil generates heat after being electrically-coupled to cause a rise in temperature within the rotor, and friction between the rotor at high speed and the air is another main factor that leads to generation of heat within the motor, resulting in a further rise in the temperature of the motor. This rise produces a thermal effect that greatly reduces the efficiency of the motor as well as shortens the service life of the motor. Therefore, it has been continuously under investigation in the art to cool down the motor or lower the temperature of the motor.

Japanese Publication No. 2002-78282 discloses a fully-enclosed motor, in which an electric fan is arranged to forcedly take out hot air produced in the interior of the motor to attain a cooling purpose. However, this kind of motor suffers from relatively complicated structure and high manufacturing cost.

Japanese Publication No. 57-77889 discloses another fully-enclosed motor, in which an electric fan is arranged externally to increase the difference in air pressure between the interior and exterior of the motor, thereby to forcedly take out hot air produced in the interior of the motor to attain a cooling purpose. Due to an external arrangement of the electric fan, the dimension of this kind of motor is larger than an ordinary motor of the same power, resulting in limited applications thereof.

Chinese Patent No. 03233067.7 discloses an internally cooled motor with external ring. This motor is provided with air-flow orifices on its front/rear end covers and with an electric fan at its rear end. For this motor, the overall size of the cooling means is relatively large and the noise brought about by the electric fan is relatively high.

Cooling liquids are also commonly used for cooling down large-scale motors and generators.

It can been seen from the above that motors with an internally-disposed cooling means or with an externally-disposed cooling means using either air or liquids as a cooling medium, or combination thereof, are commonly available in the art, but each of them has its own drawbacks. Generally speaking, use of liquid produces a cooling effect better than that produced by air cooling because the liquid has a high efficient heat conductivity, but complicated and large structure is required for such a motor because consideration must be taken to the accompanying problems such as sealing of the liquid. As a result, it is expensive to make a motor using liquid as a cooling medium. Usually, cooling means intended for being externally disposed is simple in structure and inexpensive to manufacture, but causes the overall size of the motor to become large and its applications are therefore subject to limited circumstances.

In the fields of civil applications, particularly in association with remotely controlled model airplanes, vehicles, ships, and manual tools, the motor using an internally-disposed air cooling system is regarded as a better choice from a comprehensive analysis of the relevant aspects including cooling structure, cooling effect, manufacturing cost, overall size of the motor. It remains to be settled for a skilled in the art to obtain a motor having compact structure, good cooling effect and low production cost.

### SUMMARY OF THE INVENTION

An air-cooled motor is presented, which overcomes the problems noted above and has compact structure with a good cooling effect.

To attain this, an air-cooled motor comprises a motor shaft, a stator and a rotor which are disposed co-axially, said motor shaft being fitted with a fixed seat for supporting said stator and being operatably connected with said rotor and rotatably connected with said stator, said stator having a coil coupled to conductive wires; further comprises a front cover which is disposed at the front side of said rotor and has wind channels, characterized in that a front end portion of said rotor in the proximity of said front cover is provided with an air-inflow disk which is formed as an extension portion of said front end portion extending towards the axis of said rotor in the radial direction of said rotor and which has one or more air intake grooves each passing obliquely therethrough to form a windward angle relative to the rotation direction of said rotor; and in that said motor further comprises an air-exhausting disk which is disposed at the rear side of said rotor and which has one or more air outlet grooves each passing obliquely therethrough to form a windward angle relative to the rotation direction of said rotor, said air-exhausting disk being connected fixedly with said rotor.

In one preferred embodiment of the invention, said air-inflow disk is disposed separately from and connected fixedly with said rotor.

Preferably, said air-inflow disk is disposed co-axially with said motor shaft and connected rotatably with said fixed seat of said stator.

Preferably, said fixed seat has a wire guide slot via which said conductive wires pass through said air-inflow disk.

Preferably, said air-intake grooves of said air-inflow disk are distributed in a round array.

Said windward angle is preferably in the range of 15° to 45°.

In a further embodiment of the invention, said air-intake grooves of said air-inflow disk are preferably distributed in a round array.

Said air intake groove and said outlet groove are both preferably formed as an opening.

In a further preferred embodiment of the invention, said air-inflow disk is provided with 8 to 20 air intake openings and said air-exhausting disk is provided with 10 to 16 air outlet openings.

According to the invention, threaded connection, screwed connection, welding connection, adhesive connection or riveting connection may be used for fixed connection.

A main structural improvement is made to the motor according to the invention in that the front portion of the rotor is arranged with an air-inflow disk having one or more oblique air intake grooves. In the operational mode of the motor, the air-inflow disk is driven by the rotor to rotate at a high speed so that each of the air intake grooves forms a windward angle in its oblique direction relative to the rotation direction of the rotor. This design of windward angles enables the air intake grooves rotating at a high speed to forcedly bring cooling air flows into the interior of the motor of the invention in its operational state, thereby a forced cooling effect is achieved. Apart from this, the internal compact cooling arrangement allows the motor of the invention to be produced inexpensively and in a relatively small size. Consequently, it has a wide range of applications and good adaptability.

The air-cooled motor of the invention is also provided at the rear end of the rotor with an air-exhausting disk having one or more oblique air outlet grooves. Likewise, each of the air outlet grooves forms a windward angle in its oblique direction relative to the rotation direction of the rotor, which enables the air outlet grooves rotating at a high speed to forcedly take hot air flows out of the interior of the motor of the invention in its operational state. The combined effect of the air-inflow disk and the air-exhausting disk provides a higher cooling efficiency of the motor of the invention.

The invention will now be described in more detail with reference to the accompanying figure drawings.

### BRIEF DESCRIPTION OF THE DRAWINGS

FIG. 1 is a perspective exploded view of the construction of the air-cooled motor according to one embodiment of the invention.

FIG. 2 is a diagram of cooling air flows in the air-cooled motor of the invention in its operational state.

FIG. 3 is a perspective exploded view of the construction of the air-cooled motor according to another embodiment of the invention.

FIG. 4 is a partially perspective view of the air-inflow disk as shown in FIG. 3.

FIG. 5 is another partially perspective view of the air-inflow disk as shown in FIG. 3.

FIG. 6 is a partially perspective view of the air-exhausting disk as shown in FIG. 3.

### DETAILED DESCRIPTION OF THE INVENTION

Referring now to the drawings wherein the showings are for purposes of illustrating preferred embodiments of the present invention only, and not for purposes of limiting the same.

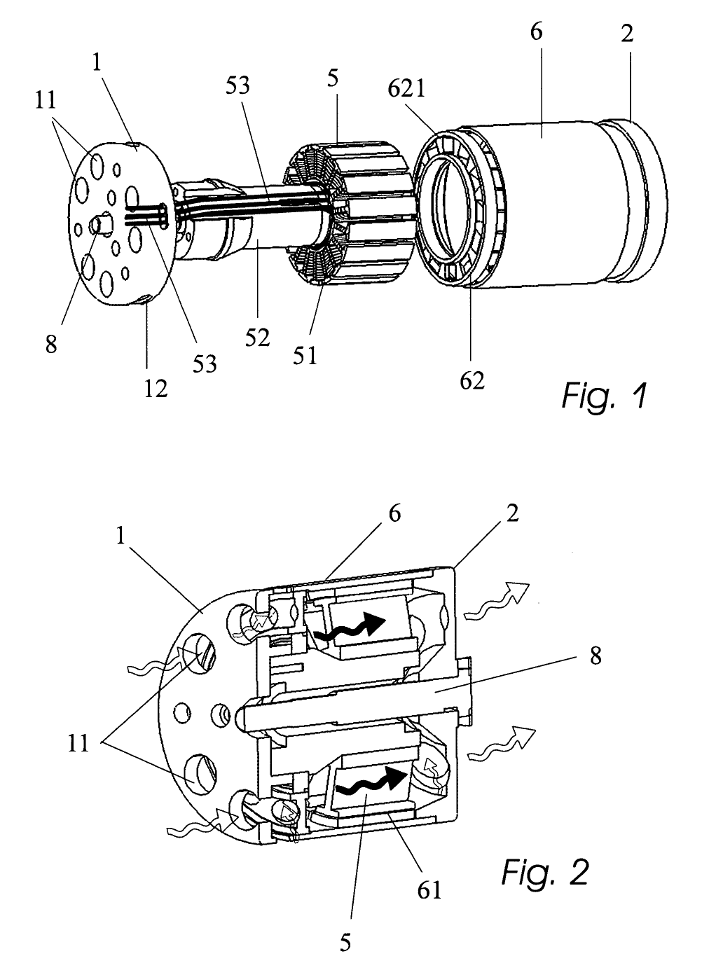

FIG. 1 illustrates an air-cooled motor consistent with a first preferred embodiment of the present invention. In this embodiment, the motor comprises a motor shaft 8, a stator 5 and a rotor 6 which are co-axially disposed with the motor shaft 8. The stator 5 has at its front side a front cover 1 on which wind tunnels 11 and a central hole are arranged. The motor shaft 8 passes through the central hole of the front cover 1 to be exposed to the outside of the motor. The stator 5 is constituted by a main body which is a coil 51 coupled to conductive wires 53. The conductive wires 53 are connected with an external power source for bringing energization to the coil 51 in the operational state of the motor. The motor shaft 8 is axially fitted with a fixed seat 52 for supporting the stator 5. The fixed seat 52 is fixedly connected with the front cover 1 and rotatably connected with the motor shaft 8 though a bearing. The rotor 6 is formed as a cylindrical ring made from metal (e.g. from iron in this embodiment), which ring has an effective inner diameter slightly larger than an outer diameter of the stator 5. Magnets 61 are uniformly distributed along the internal circumferential surface of the rotor 6. It should be understood that the magnets 61 are positioned in relation to the coil 51 so as to ensure generation of an electromagnetic effect strong enough to actuate rotation of the rotor 6 in their operating state.

An air-inflow disk 62 is arranged at a front end portion of the rotor 6 in the proximity of the front cover 1, which is formed as an extension portion of said front end portion extending towards the axis of the rotor 6 in the radial direction of said rotor. The air-inflow disk 62 has an end face with a plurality of air intake grooves 621 which are distributed in a round array and pass independently obliquely through the interior and exterior of the motor. It is of importance that the air intake grooves 621 are obliqued such that said air intake grooves 621 each lies at an acute angle relative to the rotation direction of the rotor 6, allowing the air intake groove 621 to form a windward angle on the air-inflow disk 62 at the time of rotation of the rotor 6.

The rotor 6 is followed at its rear end portion by an air-exhausting disk 2 which is connected fixedly with the rotor 6 and is caused to rotate with the rotor 6 at the same speed. Likewise, the air-exhausting disk 2 has an end face with a plurality of air outlet grooves 21 which pass independently obliquely through the interior and exterior of the motor (see FIG. 6). The air outlet grooves 21 are obliqued such that said air outlet grooves 21 each lies at an acute angle relative to the rotation direction of the rotor 6, allowing the air outlet groove 21 to form a windward angle on the air-exhausting disk 2 when rotating with the rotor 6.

FIG. 2 is a diagram of cooling air flows flowing along the arrows in the air-cooled motor of the invention in its operational state. When the motor is running, the front cover 1, the stator 5, the coil 51, the fixing seat 52 and the conductive wire 53 are in a static state. The coil 51 is electrically connected with the external power source through the conductive wires 53. The rotor 6 is caused to rotate at a high speed by the electromagnetic effect produced from interaction of the magnets 61 and the energized coil 51, and then in turn drives the motor shaft 8, the air-inflow disk 62 and the air-exhausting disk 2 to rotate at the same speed, the air-intake grooves 621 on the air-inflow disk 62 is also actuated to rotate with the rotor 6 at the high speed. The oblique arrangement of the air-intake grooves 621, when rotating at the high speed, allows formation of a plurality of windward angles in relation with the rotor 6, thereby to forcedly enable introduction of cooling air flows around the vicinity of the air intake grooves on the exterior of the motor into the interior of the motor through the air intake grooves 621. This aerodynamic principle is generally same as that of a fan. The cooling air flows introduced into the interior of the motor lead to a greater difference in air pressure between the interior and exterior of the motor and therefore increase the efficiency of air exchange between the interior and exterior of the motor. Thus, the motor is efficiently cooled down. It is noted that the air-inflow disk 62 is formed as an extension portion of the front end portion of the rotor 6 and positioned between the space defined by the rotor 6 and the front cover 1, allowing the motor to be produced in a compact mode and in a relatively small size.

The air outlet grooves 21 on the air-exhausting disk 2 also rotate with the rotor 6 at the high speed when the motor is running. The oblique arrangement of the air outlet grooves 21, when rotating at the high speed, allows formation of a plurality of windward angles in relation with the rotor 6, thereby forcedly to enable removal out of the motor of hot air flows around the vicinity of the air outlet grooves in the interior of the motor. This further increases the difference in air pressure between front and rear ends of the interior of the motor with a consequence of enhancement in rapid flowing of the cooling air flows from the front end to the rear end of the interior of the motor. In this way, the efficiency of air exchange between the interior and exterior of the motor is further improved, providing a better cooling effect.

In addition, the front cover 1 is provided with air slots 12 along its side wall to define more air flow channels. The air slots 12 are symmetrically arranged in order to keep dynamic balance of the front cover 1. Generally, the number of air slots 12 is two or four.

According to the invention, selection of value of the windward angles is critical for achievement of high efficiency of the motor. If this value is too large, the air resistance will be significantly increased when the air-exhausting disk 62 rotates at high speed, with a result that the speed of the rotor 6 is decreased and the working efficiency of the motor is reduced. If this value is too small, air volume introduced into the motor will be insufficient to obtain a good cooling effect, which in turn impairs the working efficiency of the motor. The windward angle is preferably selected from between 15° and 45°.

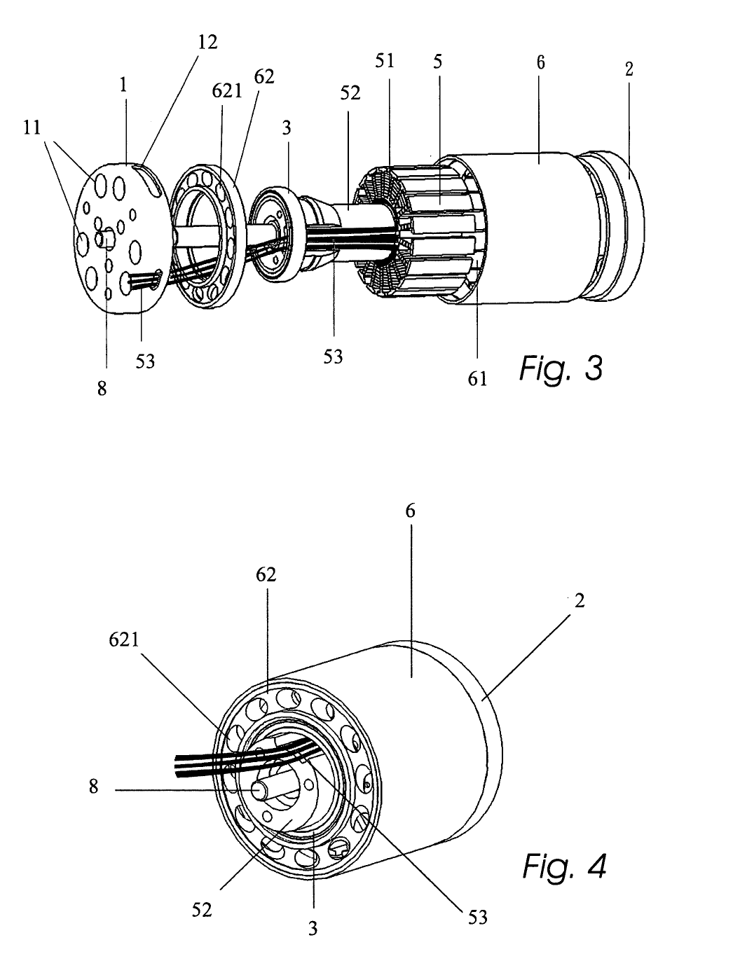

Referring now to FIG. 3, an air-cooled motor consistent with a second embodiment of the invention is shown. This embodiment is similar in structure to that disclosed in the first embodiment, but significantly differing in that the air-inflow disk 62 is arranged separately from the rotor 6. The air-inflow disk 62 is disposed co-axially with the motor shaft 8 and rotatably connected with the fixed seat 52 for supporting the stator through a bearing 3. The air-inflow disk 62, after being assembled, is integrated with the rotor 6 in a fixed manner by welding technology.

Conventional techniques in the art such as threaded connection, screwed connection, adhesive connection or riveting connection may be used to attain said fixed connection.

The fact that the air-inflow disk 62 is arranged separately from the rotor allows reduction in coaxiality precision thereby to reduce the manufacturing cost and provides convenience for their installation and adjustment. Referring to FIG. 4, the bearing 3 is used to rotatably connect the air-inflow disk 62 and the fixed seat 52. Such a rotable connection enables to create a new rotary supporting point for the rotor 6, i.e. the rotor 6 has an additional rotary supporting point compared with motors in existence so that the rotor 6 may rotate in a more stable and efficient mode with less noise.

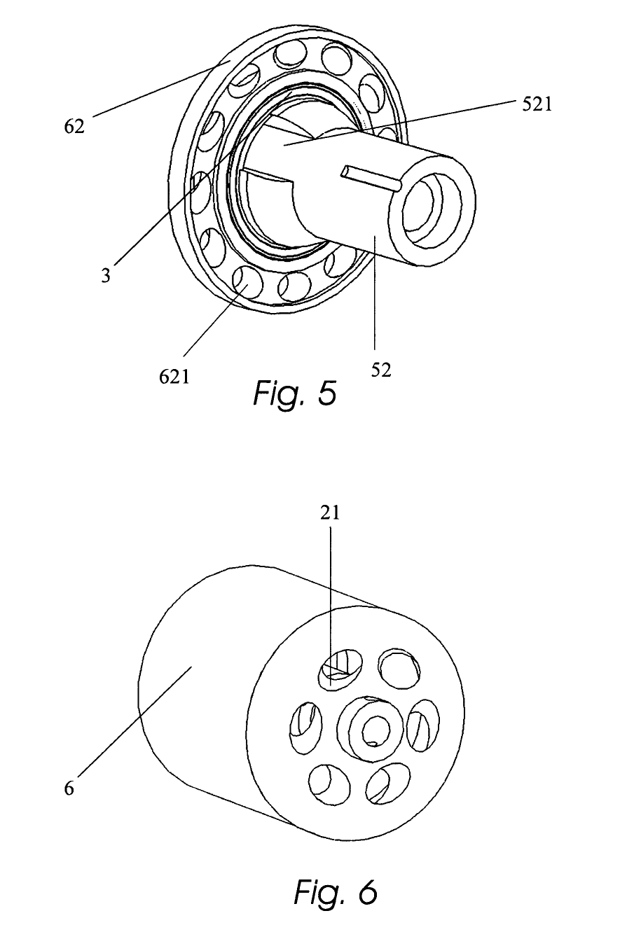

Referring now to FIG. 5, the fixed seat 52 has a wire guide slot 521 in order that the conductive wires 53 run through the air-inflow disk 62 without interfering with rotation of the air-inflow disk 62. The wire guide slot 521 allows the conductive wires 53 to run through the air-inflow disk 62 between an inner ring of the bearing 3 and the fixed seat 52 to come out of the front cover 1 to be connected with the external power source. This structural design represents a prominent progress because it solves the unsettled problem of desiring to add a new rotary supporting point for the rotor but fail to enable the rotor wires to pass through between the two rotary supporting points.

Considering the fact that round-shaped openings are industrially produced in a relatively easy and inexpensive way, the air intake grooves 621 and the air outlet grooves 21 are round-shaped in this embodiment to become air intake openings and air outlet openings, respectively. Both the air intake openings and the air outlet openings are distributed in a round array to achieve dynamic balance of the air-inflow disk 62 and the air-exhausting disk 2.

Preferably, the number of the air intake openings or the air outlet openings is selected from between 8 and 20, and more preferably between 10 and 16. In this embodiment, this number is 12.

Having sufficiently described the nature of the present invention, it is stated that insofar as its basic principle is not altered, changed or modified it may be subjected to variations of detail. Numerous variations and modifications that are easily obtainable by means of the skilled person's common knowledge without departing from the scope of the invention should fall into the scope of this invention.

What is claimed is:

1. An air-cooled motor, comprising a motor shaft, a stator and a rotor which are disposed co-axially, said motor shaft being fitted with a fixed seat for supporting said stator and being operatably connected with said rotor and rotatably connected with said stator, said stator having a coil coupled to conductive wires; further comprising a front cover which is disposed at the front side of said rotor and has wind channels, characterized in that a front end portion of said rotor in the proximity of said front cover is provided with an air-inflow disk which is formed as an extension portion of said front end portion extending towards the axis of said rotor in the radial direction of said rotor and which has one or more air intake grooves each passing obliquely therethrough to form a windward angle relative to the rotation direction of said rotor; and in that said motor further comprises an air-exhausting disk which is disposed at the rear side of said rotor and which has one or more air outlet grooves each passing obliquely therethrough to form a windward angle relative to the rotation direction of said rotor, said air-exhausting disk being connected fixedly with said rotor.

2. The air-cooled motor according to claim 1, characterized in that said air-inflow disk is disposed separately from and connected fixedly with said rotor.

3. The air-cooled motor according to claim 2, characterized in that said air-inflow disk is disposed co-axially with said motor shaft and connected rotatably with said fixed seat of said stator.

4. The air-cooled motor according to claim 3, characterized in that said fixed seat has a wire guide slot via which said conductive wires pass through said air-inflow disk.

5. The air-cooled motor according to claim 1, characterized in that said windward angle is in the range of 15° to 45°.

6. The air-cooled motor according to claim 1, characterized in that said air-intake grooves of said air-inflow disk are distributed in a round array.

7. The air-cooled motor according to claim 1, characterized in that said air intake groove is formed as an opening.

8. The air-cooled motor according to claim 1, characterized in that said air outlet groove is formed as an opening.

9. The air-cooled motor according to claim 7, characterized in that there is provided with 8 to 20 air intake openings.

10. The air-cooled motor according to claim 9, characterized in that there is provided with 10 to 16 air outlet openings.

11. The air-cooled motor according to claim 1, characterized in that threaded connection, screwed connection, welding connection, adhesive connection or riveting connection is used to achieve fixed connection.
